(19) United States
(12) Patent Application Publication
(10) Pub. No.: US 2020/0191268 A1
(43) Pub. Date: Jun. 18, 2020

(54) PARKING DEVICE

(71) Applicant: TOYOTA JIDOSHA KABUSHIKI KAISHA, Toyota-shi (JP)

(72) Inventors: Taihei WAKAMATSU, Toyota-shi (JP); Masaru MORISE, Nukata-gun (JP)

(73) Assignee: TOYOTA JIDOSHA KABUSHIKI KAISHA, Toyota-shi (JP)

(21) Appl. No.: 16/695,271

(22) Filed: Nov. 26, 2019

(30) Foreign Application Priority Data
Dec. 13, 2018 (JP) 2018-233863

(51) Int. Cl. F16H 63/34; B60T 1/00

(52) U.S. Cl. CPC F16H 63/3425; B60T 1/005

(57) ABSTRACT

A parking device includes: a parking gear provided on a rotation element; a parking pawl having a protrusion to engage with the parking gear; a cam member to move and cause the protrusion to engage with the parking gear; a rotary shaft to rotate the cam member to rotate between a lock position and an unlock position; and a rolling mechanism, having a ball rotatably held thereon, provided on the parking pawl or the cam member. Further, when the rotary shaft is in the lock position, the rolling mechanism is in a contact state where the rolling mechanism is interposed between the parking pawl and the cam member, and the cam member presses the parking pawl via the ball.

### CROSS-REFERENCE TO RELATED APPLICATION(S)

The present application claims priority to and incorporates by reference the entire contents of Japanese Patent Application No. 2018-233863 filed in Japan on Dec. 13, 2018.

### BACKGROUND

The present disclosure relates to a parking device.

Japanese Laid-open Patent Publication No. H05-322043 discloses a parking device including a parking gear provided on an auxiliary shaft of an automatic transmission, a parking pawl configured to engage with the parking gear, and an arm configured to cause the parking pawl to swing in which the parking pawl has a roller provided at a tip thereof, and rolling of the roller on a cam receiving surface of the parking pawl causes the parking pawl to swing. With the configuration described in Japanese Laid-open Patent Publication No. H05-322043, when the roller goes up onto a projection on the cam receiving surface, the arm pushes up the parking pawl to cause a protrusion of the parking pawl to engage with a tooth space of the parking gear.

### SUMMARY

There is a need for providing a parking device that can reduce a disengagement load at the time of parking release and can reduce a space for installing a member that causes a parking pawl to swing.

According to an embodiment, a parking device includes: a parking gear provided on a rotation element of a power transmission; a parking pawl having a protrusion to engage with the parking gear; a cam member to move the protrusion of the parking pawl in a direction to cause the protrusion to engage with the parking gear; a rotary shaft to rotate the cam member and to rotate between a lock position, where the cam member presses the parking pawl against the parking gear, and an unlock position, where the pressing by the cam member against the parking gear is released; a detent to hold a rotation position of the rotary shaft in the lock position or the unlock position; and a rolling mechanism, having a ball rotatably held thereon, provided on the parking pawl or the cam member. Further, when the rotary shaft is in the lock position, the protrusion of the parking pawl engages with the parking gear to bring the parking device into a locked state, where the rotation element is prevented from rotating, and when the rotary shaft is in the unlock position, the protrusion of the parking pawl disengages from the parking gear to bring the parking device into an unlocked state, where the rotation element is allowed to rotate, and when the rotary shaft is in the lock position, the rolling mechanism is in a contact state where the rolling mechanism is interposed between the parking pawl and the cam member, and the cam member presses the parking pawl via the ball.

### BRIEF DESCRIPTION OF THE DRAWINGS

FIG. 1 is a diagram schematically illustrating a parking device according to a first embodiment;

FIG. 2 is a diagram schematically illustrating a case where the parking device according to the first embodiment is brought into a locked state;

FIG. 3 is a diagram schematically illustrating a parking device according to a second embodiment; and

FIG. 4 is a diagram schematically illustrating a case where the parking device according to the second embodiment is brought into the locked state.

### DETAILED DESCRIPTION OF THE PREFERRED EMBODIMENTS

In the parking device described in Japanese Laid-open Patent Publication No. H05-322043, since the roller rolls on the cam receiving surface of the parking pawl, sliding contact between a cam mechanism and the parking pawl can be prevented at the time of parking release, and a disengagement load can be reduced. However, with such a cam mechanism using a roller, a direction of contact with the roller, that is, a rotation direction of the roller is restricted, which in turn restricts a positional relation between the arm and the parking pawl. In the configuration described in Japanese Laid-open Patent Publication No. H05-322043, since the roller rolls in a longitudinal direction of the parking pawl, the cam mechanism including the roller and the arm needs to be disposed at a position on a plane extending in the longitudinal direction of the parking pawl. Therefore, a space necessary for installing the cam mechanism needs to be secured at a position where the cam mechanism faces the cam receiving surface of the parking pawl, which may lead to an increase in size of the parking device.

Hereinafter, a description will be given in detail of a parking device according to embodiments of the present disclosure with reference to the accompanied drawings. Note that the present disclosure is not limited to the following embodiments.

### First Embodiment

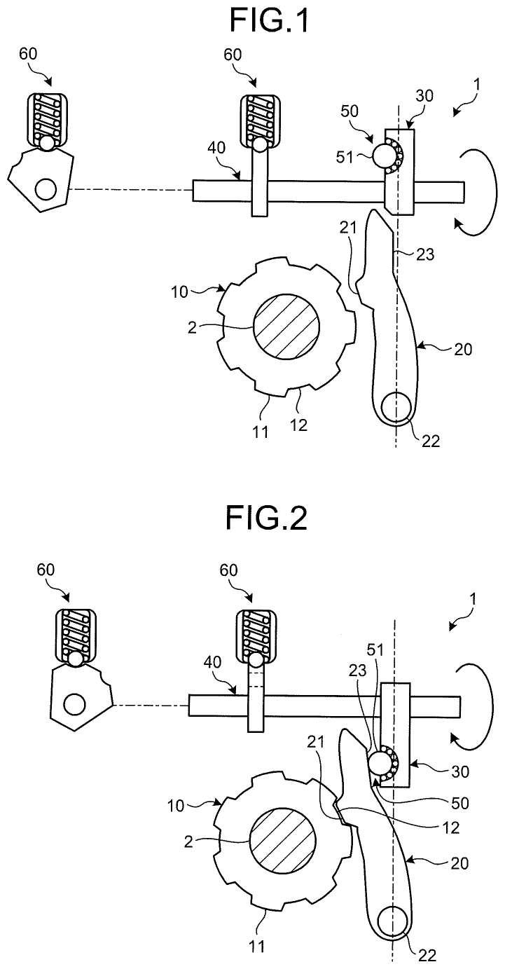

FIG. 1 is a diagram schematically illustrating a parking device according to a first embodiment. FIG. 2 is a diagram schematically illustrating a case where the parking device according to the first embodiment is brought into a locked state. Note that FIG. 1 illustrates a case where the parking device is brought into an unlocked state.

As illustrated in FIG. 1, a parking device 1 according to the first embodiment includes a parking gear 10, a parking pawl 20, a cam member 30, a rotary shaft 40, and a rolling mechanism 50. The parking device 1 is a parking lock mechanism, which prevents an output shaft 2 of an automatic transmission from rotating.

The parking gear 10 is an external gear provided on the output shaft 2 and rotates together with the output shaft 2. A plurality of teeth 11 are provided on a periphery of the parking gear 10 at predetermined intervals in a circumferential direction. A tooth space 12 is formed between teeth 11, 11 adjacent to each other in the circumferential direction. The parking pawl 20 is disposed outside in a radial direction of the parking gear 10.

The parking pawl 20 has a protrusion (hook portion) 21 capable of engaging with the tooth space 12 of the parking gear 10. The protrusion 21 is provided at a position on the parking pawl 20 where the protrusion 21 faces the periphery of the parking gear 10. Further, the parking pawl 20 is pivotably supported by a pivot pin 22 provided at one end in a longitudinal direction of the parking pawl 20. That is, the other end of the parking pawl 20 swings around the pivot pin 22. The protrusion 21 is provided on the other end of a center in the longitudinal direction of the parking pawl 20.

The parking pawl 20 pivots (rotates) about the pivot pin 22 to allow the protrusion 21 to swing between an engagement position, where the protrusion 21 engages with the tooth space 12 of the parking gear 10, and a disengagement position, where the protrusion 21 disengages from the tooth space 12. The parking pawl 20 in a position illustrated in FIG. 2 is in the engagement position, and the parking pawl 20 in a position illustrated in FIG. 1 is in the disengagement position. Note that the parking pawl 20 is pressed in a direction (toward the disengagement position) away from the parking gear 10 by a spring (not illustrated).

The cam member 30 is a member that constitutes a mechanism, which causes the parking pawl 20 to swing and to press the protrusion 21 of the parking pawl 20 against the parking gear 10. As illustrated in FIG. 1 and FIG. 2, the cam member 30 is provided on the rotary shaft 40 and rotates together with the rotary shaft 40. Further, the cam member 30 is provided with the rolling mechanism 50. The cam member 30 presses the parking pawl 20 via the rolling mechanism 50.

The rotary shaft 40 is a shaft disposed on an axis that is not coplanar with a rotation center axis of the output shaft 2, and rotates between a lock position and an unlock position. The lock position and the unlock position are rotation positions (phases) of the rotary shaft 40. When the rotary shaft 40 is in the lock position, the cam member 30 is displaced to cause the protrusion 21 of the parking pawl 20 to engage with the tooth space 12 of the parking gear 10, entering the locked state where the parking gear 10 and the output shaft 2 are prevented from rotating (see FIG. 2). When the rotary shaft 40 is in the unlock position, the cam member 30 is displaced to cause the protrusion 21 to disengage from the tooth space 12 of the parking gear 10, entering the unlocked state where the parking gear 10 and the output shaft 2 are allowed to rotate (see FIG. 1). That is, the parking device 1 is switched between the locked state and the unlocked state by the rotation of the rotary shaft 40.

For example, the rotary shaft 40 is connected to an actuator, and the actuator rotates the rotary shaft 40. Alternatively, the rotary shaft 40 is connected to a shift lever (not illustrated), and the operation of the shift lever rotates the rotary shaft 40. When the shift lever is operated to a parking range (P range), the rotary shaft 40 rotates to the lock position.

The rolling mechanism 50 has a ball 51, which is rotatably held. The ball 51 is rotatably held with being partially exposed. When the rotary shaft 40 is in the unlock position, the ball 51 is separated from the parking pawl 20. Conversely, when the rotary shaft 40 is in the lock position, the ball 51 is in contact with the parking pawl 20. When the ball 51 is in contact with the parking pawl 20, the ball 51 is in a contact state where the ball 51 is interposed between the cam member 30 and the parking pawl 20.

Hereinafter, a description will be given in detail of operation performed when the parking device 1 according to the first embodiment is switched between the locked state and the unlocked state.

As illustrated in FIG. 1, in the unlocked state where the rotation position of the rotary shaft 40 is the unlock position, the cam member 30 is in a position where the cam member 30 does not face a back side of the parking pawl 20. In this case, the rolling mechanism 50 attached to the cam member 30 is also in a position where the rolling mechanism 50 does not face the back side of the parking pawl 20. That is, since the ball 51 of the rolling mechanism 50 does not press the parking pawl 20, the protrusion 21 of the parking pawl 20 is in a position separate from the tooth space 12 of the parking gear 10. Accordingly, the parking pawl 20 disengages from the parking gear 10, and thus the output shaft 2 is brought into a state where the output shaft 2 is allowed to rotate.

When the rotary shaft 40 rotates from the unlock position toward the lock position, the cam member 30 moves to a position where the cam member 30 faces the back side of the parking pawl 20. That is, the ball 51 of the rolling mechanism 50 provided on the cam member 30 also moves to a position where the ball 51 faces the back side of the parking pawl 20. Then, just before the rotation position of the rotary shaft 40 reaches the lock position, the ball 51 of the rolling mechanism 50 comes into contact with a cam receiving surface 23 on the back side of the parking pawl 20. The ball 51 after making contact with the cam receiving surface 23 rolls on the cam receiving surface 23 of the parking pawl 20 in a rotation direction of the rotary shaft 40 until the cam member 30 reaches the lock position. Thereafter, when the rotation position of the rotary shaft 40 reaches the lock position, it enters the locked state where the cam member 30 presses the protrusion 21 of the parking pawl 20 against the tooth space 12 of the parking gear 10 via the ball 51. In this locked state, the rotary shaft 40 is held by a detent 60 in a state where the rotation position of the rotary shaft 40 is fixed in the lock position.

Further, when the rotary shaft 40 held in the lock position by the detent 60 is released from the locked state, the rotary shaft 40 is allowed to rotate from the lock position toward the unlock position. When the rotary shaft 40 rotates from the lock position toward the unlock position, the ball 51 in contact with the cam receiving surface 23 rolls on the cam receiving surface 23 of the parking pawl 20 in the rotation direction of the rotary shaft 40 while the cam member 30 faces the back side of the parking pawl 20. Then, when the rotary shaft 40 rotates to a position where the cam member 30 does not face the back side of the parking pawl 20, the ball 51 becomes separated from the parking pawl 20. This releases the parking pawl 20 from a state where the cam member 30 presses the parking pawl 20 via the rolling mechanism 50. In this case, the parking pawl 20 swings in the unlock direction to cause the protrusion 21 to disengage from the tooth space 12 of the parking gear 10. That is, the engagement between the parking pawl 20 and the parking gear 10 is released. Thereafter, the cam member 30 is allowed to rotate together with the rotary shaft 40 until the rotary shaft 40 reaches the unlock position. In this case, after the rotary shaft 40 rotates to the unlock position, the rotation position of the rotary shaft 40 is fixed in the unlock position by the detent 60.

As described above, according to the first embodiment, when the rotary shaft 40 is in the lock position, the cam member 30 presses the parking pawl 20 via the ball 51 of the rolling mechanism 50. Therefore, when the rotary shaft 40 is switched from the lock position to the unlock position, the ball 51 rolls on the cam receiving surface 23 of the parking pawl 20, making it possible to prevent sliding friction from occurring and to reduce a disengagement torque (disengagement load) generated at the time of parking release.

Further, the ball 51 is rotatable in any direction, and thus a positional relation between the parking pawl 20 and the cam member 30 is not restricted. Therefore, the cam member 30 can be provided on the rotary shaft 40 that rotates about the axis that is not coplanar with the rotation center axis of the output shaft 2. Then, the rotation of the rotary shaft 40 allows the cam member 30 to be displaced to a position different from the back side of the parking pawl 20. As a result, a degree of freedom in disposition of the cam member 30 is increased, so that a space for disposing the cam member 30 on the back side of the parking pawl 20 can be reduced.

Note that, in the first embodiment described above, the description has been given of the configuration where the parking gear 10 is provided on the output shaft 2 of the automatic transmission, but the present disclosure is not limited to such a configuration. For example, the parking gear 10 may be provided on a drive shaft that rotates together with wheels. That is, the parking gear 10 may be provided on not only the output shaft 2 or the drive shaft, but also any rotation element as long as such a rotation element serves as a rotation element of a power transmission mounted on a vehicle.

Further, the actuator that rotates the rotary shaft 40 may be an electric actuator. For example, the electric actuator that rotates the rotary shaft 40 is capable of moving the rotary shaft 40 toward the lock position in response to detection of operation of a parking brake lever or a parking brake pedal. The electric actuator is controlled by an electronic control unit (ECU) mounted on the vehicle.

### Second Embodiment

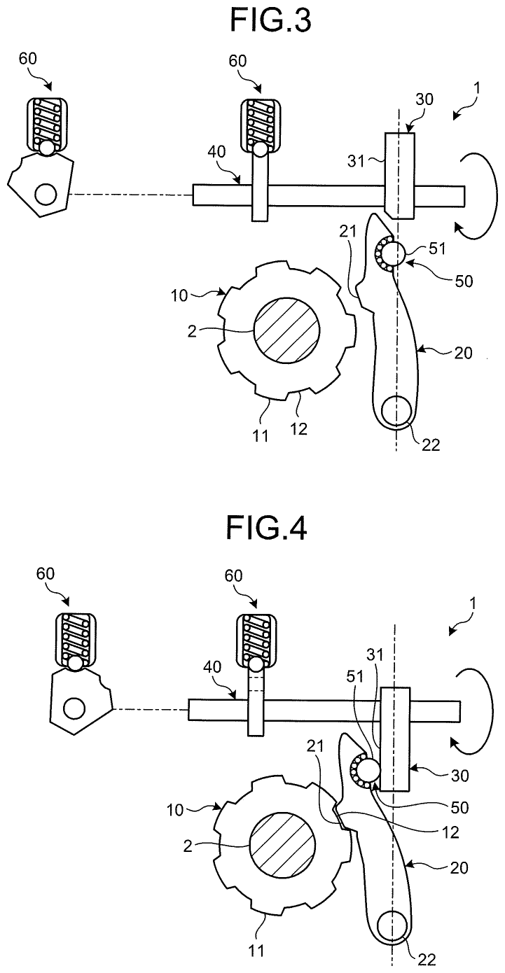

Next, a description will be given of a parking device 1 according to a second embodiment with reference to FIG. 3 and FIG. 4. According to the second embodiment, unlike the first embodiment, a rolling mechanism 50 is provided on a parking pawl 20. Note that, in the description of the second embodiment, no description will be given of the same components as the components in the first embodiment described above, and the same reference numerals of the components are used.

FIG. 3 is a diagram schematically illustrating the parking device 1 according to the second embodiment. FIG. 4 is a diagram schematically illustrating a case where the parking device 1 according to the second embodiment is brought into the locked state. Note that FIG. 3 illustrates a case where the parking device 1 is brought into the unlocked state.

The parking device 1 according to the second embodiment includes the rolling mechanism 50 provided on the parking pawl 20. The rolling mechanism 50 has a ball 51 partially exposed from a back side of the parking pawl 20. The ball 51 is rotatably held on the parking pawl 20. As illustrated in FIG. 3, the rolling mechanism 50 is provided at an end (the other end) opposite to a pivot pin 22 in the longitudinal direction of the parking pawl 20.

A cam member 30 has a cam surface 31, which comes into contact with the ball 51 of the rolling mechanism 50. As illustrated in FIG. 3, when a rotary shaft 40 is in the unlock position, the cam surface 31 of the cam member 30 is separated from the ball 51 of the rolling mechanism 50. As illustrated in FIG. 4, when the rotary shaft 40 is in the lock position, the cam surface 31 is in contact with the ball 51 of the rolling mechanism 50.

Hereinafter, a description will be given in detail of operation performed when the parking device 1 according to the second embodiment is switched between the locked state and the unlocked state.

As illustrated in FIG. 3, in the unlocked state where the rotation position of the rotary shaft 40 is the unlock position, the cam member 30 is in a position where the cam surface 31 does not face the back side of the parking pawl 20. In this case, the rolling mechanism 50 provided on the parking pawl 20 does not face the cam surface 31 of the cam member 30, either. That is, since the cam member 30 does not press the ball 51 of the rolling mechanism 50 toward the parking gear 10, a protrusion 21 of the parking pawl 20 is in a position separate from a tooth space 12 of a parking gear 10. Accordingly, the parking pawl 20 disengages from the parking gear 10, and thus an output shaft 2 is allowed to rotate.

When the rotary shaft 40 rotates from the unlock position toward the lock position, the cam surface 31 of the cam member 30 moves to a position where the cam surface 31 faces the back side of the parking pawl 20. Then, the cam surface 31 comes into contact with the ball 51 of the rolling mechanism 50. In this case, the cam surface 31 comes into contact with the ball 51 just before the rotation position of the rotary shaft 40 reaches the lock position. The cam surface 31 after making contact with the ball 51 is kept in contact with the ball 51 until the rotary shaft 40 reaches the lock position. That is, the ball 51 after making contact with the cam surface 31 rolls on the cam surface 31 in the rotation direction of the rotary shaft 40. Thereafter, when the cam member 30 reaches the lock position, it enters the locked state where the cam member 30 presses the protrusion 21 of the parking pawl 20 against the tooth space 12 of the parking gear 10 via the ball 51.

Further, when the rotary shaft 40 held in the lock position by a detent 60 is released from the locked state, the rotary shaft 40 is allowed to rotate from the lock position toward the unlock position. When the rotary shaft 40 rotates from the lock position toward the unlock position, the ball 51 in contact with the cam surface 31 rolls on the cam surface 31 in the rotation direction of the rotary shaft 40 while the cam member 30 faces the back side of the parking pawl 20. Then, when the rotary shaft 40 rotates to a position where the cam member 30 does not face the back side of the parking pawl 20, the ball 51 becomes separated from the cam member 30.

As described above, according to the second embodiment, the same effect as the effect obtained by the first embodiment described above can be obtained, the direction of contact with the ball 51 is not restricted, and thus the rolling mechanism 50 having the ball 51 can be provided on the parking pawl 20.

As in the embodiments described above, in the parking device 1, the rolling mechanism 50 having the ball 51 rotatably held may be provided on either the parking pawl 20 or the cam member 30.

Further, according to each of the embodiments described above, when the rotary shaft 40 is in the unlock position, the ball 51 is separated from the parking pawl 20 or the cam member 30, but the present disclosure is not limited to such a configuration. The ball 51 need not necessarily be separated from the parking pawl 20 or the cam member 30. That is, the ball 51 may be in contact with the parking pawl 20 or the cam member 30 all the time regardless of whether the rotary shaft 40 is in the lock position or the unlock position.

As a modification of this configuration, according to a modification of the first embodiment, the ball 51 is kept in contact with the cam receiving surface 23 of the parking pawl 20. Accordingly, when the rotary shaft 40 is in the unlock position, the cam member 30 stops pressing the parking pawl 20 with the ball 51 kept in contact with the parking pawl 20.

Similarly, according to a modification of the second embodiment, the ball 51 is kept in contact with the cam surface 31 of the cam member 30. Accordingly, when the rotary shaft 40 is in the unlock position, the cam member 30 stops pressing the parking pawl 20 with the ball 51 kept in contact with the cam member 30.

According to the present disclosure, since the cam member has a structure for pressing the parking pawl via the ball of the rolling mechanism, the direction of contact with the ball is not restricted, and the positional relation between the parking pawl and the cam member is not restricted. Therefore, the disengagement load can be reduced by the rolling mechanism at the time of parking release, and the space for installing the cam member can also be reduced.

According to an embodiment, since a direction of contact with the ball is not restricted, the cam member can be provided on the rotary shaft disposed on an axis that is not coplanar with a rotation center axis of the rotation element. This can reduce a space for installing the cam member.

According to an embodiment, the rolling mechanism provided on the cam member can press the parking pawl. Further, since a positional relation between the parking pawl and the cam member is not restricted, when the rotary shaft rotates toward the unlock position, the state where the ball presses the parking pawl can be released.

According to an embodiment, since the direction of contact of the parking pawl with the ball is not restricted, the ball can roll on the surface of the parking pawl in the rotation direction of the rotary shaft.

According to an embodiment, the cam member can be received by the rolling mechanism provided on the parking pawl. Further, since the positional relation between the parking pawl and the cam member is not restricted, when the rotary shaft rotates toward the unlock position, the state where the cam member presses the ball can be released.

According to an embodiment, since the direction of contact of the cam member with the ball is not restricted, the ball can roll on the surface of the cam member in the rotation direction of the rotary shaft.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A parking device comprising:
a parking gear provided on a rotation element of a power transmission;
a parking pawl having a protrusion configured to engage with the parking gear;
a cam member configured to move the protrusion of the parking pawl in a direction to cause the protrusion to engage with the parking gear;
a rotary shaft configured to rotate the cam member and to rotate between a lock position, where the cam member presses the parking pawl against the parking gear, and an unlock position, where the pressing by the cam member against the parking gear is released;
a detent configured to hold a rotation position of the rotary shaft in the lock position or the unlock position; and
a rolling mechanism, having a ball rotatably held thereon, provided on the parking pawl or the cam member, wherein
when the rotary shaft is in the lock position, the protrusion of the parking pawl engages with the parking gear to bring the parking device into a locked state, where the rotation element is prevented from rotating, and when the rotary shaft is in the unlock position, the protrusion of the parking pawl disengages from the parking gear to bring the parking device into an unlocked state, where the rotation element is allowed to rotate, and
when the rotary shaft is in the lock position, the rolling mechanism is in a contact state where the rolling mechanism is interposed between the parking pawl and the cam member, and the cam member presses the parking pawl via the ball.

2. The parking device according to claim 1, wherein
the rotary shaft is disposed on an axis that is not coplanar with a rotation center axis of the rotation element.

3. The parking device according to claim 1, wherein
the rolling mechanism is provided on the cam member,
when the rotary shaft is in the lock position, the ball is in contact with the parking pawl, and the cam member presses the parking pawl via the ball, and
when the rotary shaft is in the unlock position, the pressing by cam member against the parking pawl is released. The parking device according to claim 3, wherein
the ball rolls on a surface of the parking pawl in a rotation direction of the rotary shaft while the rotary shaft is rotating between the lock position and the unlock position.

5. The parking device according to claim 1, wherein
the rolling mechanism is provided on the parking pawl,
when the rotary shaft is in the lock position, the cam member is in contact with the ball, and the cam member presses the parking pawl via the ball, and
when the rotary shaft is in the unlock position, the pressing by the cam member against the parking pawl is released.

6. The parking device according to claim 5, wherein
the ball rolls on a surface of the cam member in a rotation direction of the rotary shaft while the rotary shaft is rotating between the lock position and the unlock position.
